(19) United States
(12) Patent Application Publication
(10) Pub. No.: US 2005/0055230 A1
(43) Pub. Date: Mar. 10, 2005

(54) Method for manufacturer's depot exhibition space

(76) Inventor: Yulin Chen, Shenzhen (CN)

Correspondence Address: Let Z. Kwan, 2263 Vandalia Ave., Los Angeles, CA, 90032, US

(21) Appl. No.: 10/659,607

(22) Filed: Sep. 10, 2003

(51) Int. Cl. G06F 17/60

(52) U.S. Cl. 705/1; 705/10

(57) ABSTRACT

The present invention relates to a new and improved method for preparing a manufacturer's depot exhibition space. The method includes acquiring a real property right to a structure to provide the manufacturer's depot exhibition space in a specific location, wherein the real property right includes a leasing right or an ownership right, contracting an agreement with a plurality of manufacturers, the agreement including a lease of an exhibition space within the manufacturer's depot exhibition space to provide a unique exhibition space, wherein the lease includes a term greater than a bi-monthly term, customizing the exhibition space to provide the plurality of manufacturers with a permanent location to showcase and sell a product, wherein the product is relative to each of the plurality of manufacturers, offering the plurality of manufacturers opportunities to meet direct customers and markets, billing the plurality of manufacturers a membership fee, establishing a storage space to provide the plurality of manufacturers with a product storage, and advertising the manufacturer's depot exhibition space.

### BACKGROUND OF THE INVENTION

1. Field of the Invention

The present invention generally relates to the field of preparing an exhibition or fair space within an enclosed and/or open space and, more particularly, to a method for a manufacturer's depot exhibition space within a fixed location on a permanent basis.

2. Brief Description of the Related Art

Currently, when a business or manufacturer desires to exhibit their merchandise in a particular location, generally in the form of stands within a space, they are limited to exhibitions carried out within a relatively short period of time, some for less than a week. The fair promoter usually contracts with manufacturers for an exhibition which normally lasts a relatively short period of time.

The manufacturer has to prepare for such exhibition for weeks in advance in order to allocate merchandise, index and prepare the product for display and sale. Some businesses require at least three weeks to prepare for exhibition in the convention center, some require as much as four months. Then the showcase usually lasts for a period of three to five days, two weeks at best. At that point, the manufacturer is required to either re-pack the remaining merchandise not sold within the time period of the convention, or sell the product at a low cost.

In the current state of the art, the exhibitions are opened for a limited amount of time. The manufacturer could spend many months preparing for the exhibition. Once all of the product is assembled, the manufacturer ships the goods to the exhibition. Each exhibition lasting only a short time, the manufacturer is then forced into either selling his goods at a lower price or re-packing the goods to ship back to its main warehouse. One problem is that during each such shipment, there is opportunity for the goods to be damaged in transit.

Demand by the international manufacturers for a better avenue to showcase their product increases as the demand increases. Foreign commodities, especially commodities made in China, are increasing in demand from international markets. Currently, the biggest European retailer, Kingfisher Group from the U.K., purchased 40% commodities from China. International big supermarket groups, like Wal-mart, Carefour, have moved their purchasing centers from Taiwan and Hong Kong to mainland China in an effort to supply the manufacturers with a better avenue of commerce.

Even with increases in demand for foreign commodities, such as China, a majority of export and import business from Chinese companies is still going through middlemen. Such reliance on a middleman generates lost income and possible revenue for the manufacturer, as well as increased costs to the buyer. For instance, a German company purchased 100 million USD products from Asia, among them 90% of the products were made in China. Corresponding to the Chinese products were approximately 300 Chinese manufacturers. The direct trade between these companies and the Germany company was approximately 25% with the remaining 75% done via a middleman. The end result was, as stated above, lost revenue and increased prices.

China is on it's way to becoming one of the world's largest manufacturing centers. As more and more foreign companies are entering China, more and more Chinese companies have accumulated sufficient experience in dealing with foreign companies and ample capital to explore the foreign market themselves. They recognize that America is the largest market in the world. Hence, America is the ultimate market the Chinese companies to enter into. As stated by the World Economic Forum Asia Affairs Director, there will be more and more ‘Made In China’ marked commodities entering the American market in the near future. He predicted that there will be a lot more of Chinese companies doing business in the United States, much like Japanese and Korean companies initiated in the past.

However, the Chinese companies are facing serious challenges in establishing new avenues of commerce in a new U.S. market: First, many lack the ability to deal directly with the United States' target markets on their own, without the assistance of a middleman. Most of the Chinese companies do not localize their marketing force in the U.S. but rather rely on third parties thereby significantly increasing their costs. Second, the American market is currently flooded with low quality products made in China. The result of which is that such products overshadow the quality of products made in China, which have no place to present themselves to the consumers in the target market. Third, most Chinese companies are forced into short-term marketing of their product instead of any long-term strategic planning. Forth, the manufacturers do not have a platform to meet and communicate with target clients directly. And lastly, they do not have the state-of-the-art technologies to market their products such as a centralized website.

Many Chinese companies do participate in the short-term American Exhibitions of their industries because the high costs associated with entering into the United States market. The preparation time of a foreign manufacturer for today's exhibitions is short. The companies do not want to spend too much money in making necessary preparations for such exhibitions lasting only days. Even when such companies do participate in these short term exhibitions, many end up with exhibition booths poorly designed and ambiguous. The short term exhibition only offers the Chinese companies a glimpse of establishing long term product exhibitions. Once the manufacturer has prepared, shipped, set up, begun exhibiting it's product and generally getting warmed up to do business in the U.S., the convention is over and it is time to pack up and go. Chinese companies and their American customers seemingly have to be an ocean apart before engaging in business negotiations or business development.

Moreover, many Chinese companies lack the knowledge regarding the target market customers' needs nor an avenue of how to obtain such information. Many have never had direct contact with the market customers. Their products tend to be not so user-friendly, and their services may lag far behind. In addition, the companies do not communicate and network with the customers for a period long enough to build up the business relationship between them. Many of the representatives have language and cultural barriers which present another problem in the relationship between the Chinese manufacturers and the United States target market.

The present invention solves the problem of the short-term convention centers by establishing a long-term showroom and wholesale center. It provides a fixed, permanent location where manufacturers can lessen any damages to the goods by not having to successively pack and re-pack and ship from one short term exhibition to another.

The present invention combines the convention centers and large scale retailers by offering a location, opportunities and assistance for manufacturers and their products thereby enabling direct contact with their customers. The customers have the ability to place unique orders with a specific design directly to the manufacturer. Orders can be placed directly from the showroom floor.

### SUMMARY OF THE INVENTION

Accordingly, the instant invention provides a method for a manufacturer's depot exhibition space within a fixed location on a permanent basis.

According to a first exemplary embodiment, a method for preparing a manufacturer's depot exhibition space is provided. The method includes acquiring a real property right to a structure to provide the manufacturer's depot exhibition space in a specific location, wherein the real property right includes a leasing right or an ownership right, contracting an agreement with a plurality of manufacturers, the agreement including a lease of an exhibition space within the manufacturer's depot exhibition space to provide a unique exhibition space, wherein the lease includes a term greater than a bi-monthly term, customizing the exhibition space to provide the plurality of manufacturers with a permanent location to showcase and sell a product, wherein the product is relative to each of the plurality of manufacturers, offering the plurality of manufacturers opportunities to meet direct customers and markets, billing the plurality of manufacturers a membership fee, establishing a storage space to provide the plurality of manufacturers with a product storage, and advertising the manufacturer's depot exhibition space.

According to a second exemplary embodiment, a method for preparing a manufacturer's depot exhibition space is provided. The method includes surveying a plurality of manufacturers to provide a detailed account of a manufacturer's business, wherein the manufacturer's business includes information corresponding to a product, contracting an agreement with the plurality of manufacturers, the agreement including a lease of a unique exhibition space corresponding respectively to each of the plurality of manufacturers, customizing the unique exhibition space to provide the plurality of manufacturers with a permanent location to showcase and sell the product, and

showcasing the product corresponding respectively to each of the plurality of manufacturers on a permanent basis.

According to a third exemplary embodiment, a method for preparing a manufacturer's depot exhibition space is provided. The method includes leasing to a plurality of manufacturers a unique exhibition space corresponding respectively to each of the plurality of manufacturers to provide a long term exhibition space, wherein the leasing includes a lease term greater than 29 days, customizing the unique exhibition space to provide the plurality of manufacturers with the long term exhibition space to showcase and sell a product, wherein the product corresponds respectively to each of the plurality of manufacturers, showcasing the product, and selling the product.

Still other objects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to preferred embodiments of the apparatus and method, given only by way of example, and with reference to the accompanying drawings, in which:

FIG. 1 illustrates a flowchart useful in describing an exemplary method for preparing a manufacturer's depot exhibition space;

FIG. 2 illustrates a flowchart useful in describing another exemplary method for preparing a manufacturer's depot exhibition space; and

FIG. 3 illustrates a flowchart useful in describing another exemplary method for preparing a manufacturer's depot exhibition space.

### DETAILED DESCRIPTION OF THE PREFERRED EMBODIMENT

Referring to the drawing figures, like reference numerals designate identical or corresponding elements throughout the several figures.

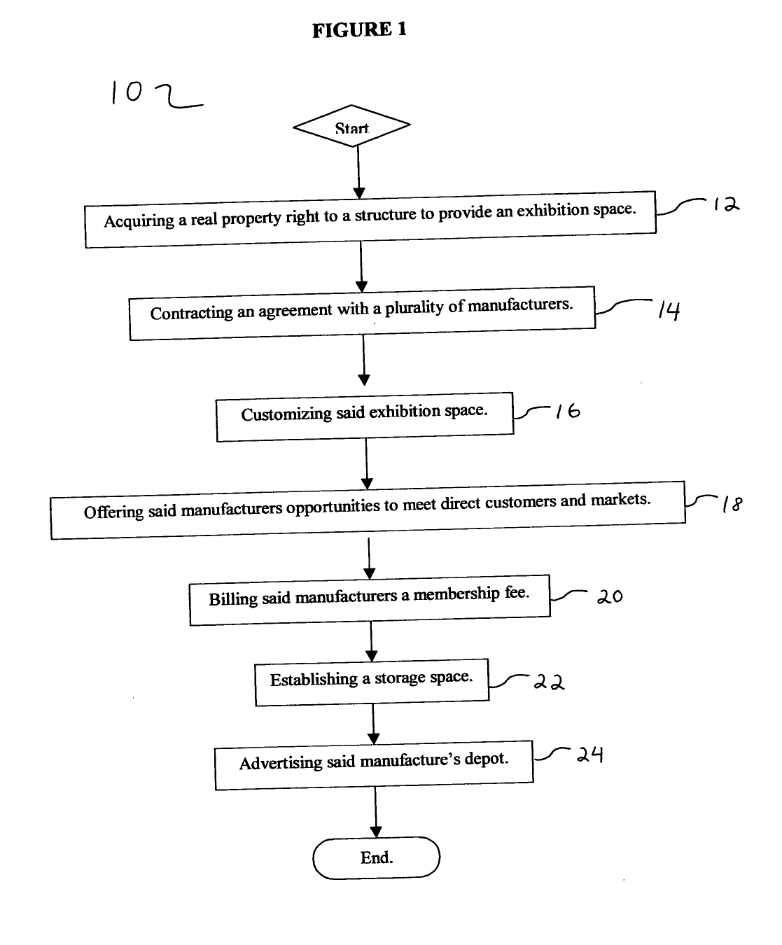

The invention provided is a business method for preparing an exhibition space for manufacturers. FIG. 1 illustrates a flowchart useful in describing an exemplary method for preparing a manufacturer's depot exhibition space and is generally referenced by the numeral 10. The method 10 begins by acquiring a real property right to a structure to provide said manufacturer's depot exhibition space in a specific location, as indicated at 12. The specific location may include major metropolitan cities, towns, municipalities, neighborhoods and zoned areas of a major metropolitan city. By way of example and not limitation, the major metropolitan city may be Los Angeles, San Francisco, Miami, New York, Chicago, Detroit, Cleveland, San Diego, New Orleans, Washington D.C., Las Vegas. The real property right may be for landlord/tenant rights for a lease term contained in a lease agreement or ownership rights contained in a seller/buyer purchase agreement or other legal instrument.

Next is contracting an agreement with a plurality of manufacturers, as indicated at 14. The agreement may include a lease of an exhibition space within the manufacturer's depot exhibition space to provide a unique exhibition space. The lease may be for a term greater than bi-monthly and on a permanent basis relative to terms greater than 29 days. Then method 10 customizes the exhibition space to provide the manufacturers with a permanent location to showcase and sell a product, as indicated at 16. The product is relative to each of the manufacturers.

Next there is an offering to the manufacturers regarding opportunities to meet direct customers and markets, as indicated at 18. Then the manufacturer is billed a membership fee, as indicated at 20. The membership fee is relative to the term of the manufacturer's lease and any other business services requested by the manufacturer. The membership fee is at least a monthly membership fee and may be an annual membership fee.

Then there is an establishing of a storage space to provide the manufacturers with product storage, as indicated at 22. This enables the manufacturers to store product not being displayed and showcased in their unique exhibition space. The step saves the manufacturers in overhead costs associated with shipping unsold product back and forth. Finally there is advertising said manufacturer's depot exhibition space, as indicated at 24. Optionally, method 10 may include the step of surveying the plurality of manufacturers for an information packet relating to said product. The information packet could be used in conjunction with the manufacture or design of the unique exhibition space pertaining to a specific manufacturer. The product may be sold via the exhibition space on a wholesale basis directly to the public or other manufacturers.

One aspect of an embodiment includes offering to the plurality of manufacturers accommodations, food and travel arrangements within the United States. This solves the problem many foreign manufacturers now have when their agents travel to the United States for business. A further aspect of method 10 may include assisting the plurality of manufacturers with a product display design, ranging from the initial concept to production and maintenance. Another option of assisting the manufacturers includes developing a product via a market feedback and a product demand. This may be accomplished through commonly known marketing practices. Yet another aspect of assisting the manufacturers may be by offering a contact to link the manufacturers with other conventions and trade shows. This would allow for a foreign manufacturer to participate in areas of commerce in North America which otherwise may have been unknown to the manufacturer.

By way of example and not limitation, the plurality of manufacturers may include at least a group of 50 manufacturers. The manufacturers' product may be one of it's most recent on the market products, or a product that has been in production long enough not to be considered “new”.

One aspect of the present invention is to provide a “permanent” location for the manufacturers to exhibit their product. In an effort to define “permanent”, the term of the lease is at least a month. One option is for the lease term to be a year.

Another aspect of the present invention is to provide method 10 for product made in Asia. Optionally, the product may be made in China. Regarding the advertising of the exhibition space, this may be accomplished through common means of media distribution. By way of example and not limitation, the advertising may be in local media including newspaper, television, film, print, and radio.

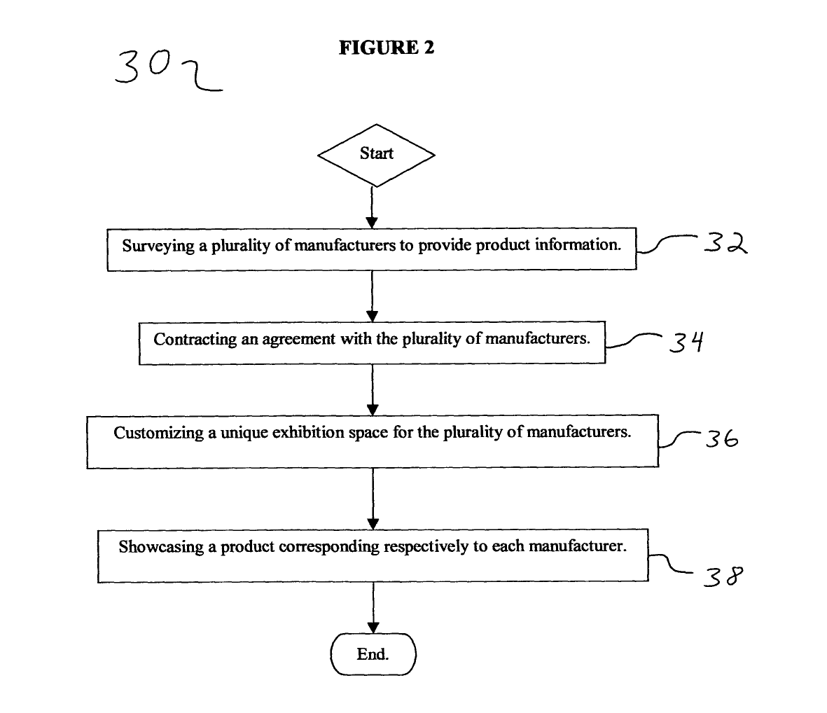

FIG. 2 illustrates a flowchart useful in describing another exemplary method for preparing a manufacturer's depot exhibition space and is generally referenced by the numeral 30. Method 30 begins surveying a plurality of manufacturers to provide a detailed account of a manufacturer's business, as indicated at 32. The detailed account of the manufacturer's business may include information corresponding to the manufacturer's product. The information could be used in conjunction with the manufacture or design of the unique exhibition space pertaining to a specific manufacturer. Another aspect is that the product may be sold via the exhibition space on a wholesale basis directly to the public or other manufacturers.

Next is contracting an agreement with the plurality of manufacturers, as indicated at 34. The agreement may include a lease of a unique exhibition space corresponding respectively to each of the plurality of manufacturers. In order to provide a more “permanent” setting, the lease term may range from a month to year(s). Then there is customizing the unique exhibition space to provide the plurality of manufacturers with the permanent location discussed above, as indicated at 36. The purpose of customizing the exhibition space is to create a unique space for each manufacturer to showcase and sell it's product, as indicated at 38. The location of the manufacturer's depot exhibition space, by way of example and not limitation, may be in a major metropolitan city, a town, a municipality, a neighborhood or a zoned area.

Optionally, the manufacturers may be offered accommodations including meals and travel within the United States while doing business with the manufacturer's depot exhibition. This solves the problem many foreign manufacturers now have when their agents travel to the United States for business. Another benefit which may be provided to the manufacturers is a storage space where the manufacturers can store unsold product. This enables the manufacturers to store product not being displayed and showcased in their unique exhibition space. It can save the manufacturers a significant amount in overhead costs associated with shipping unsold product back and forth.

Another aspect of method 30 may include advertising the manufacturer's depot exhibition space in a local media including newspaper, television, film, print, and radio. The costs associated with advertising, space and storage leasing may be included in a membership fee. By way of example and not limitation, the fee may range from a monthly membership fee to an annual membership fee or greater.

The instant invention solves a litany of problems presented to manufacturers. One aspect may include assisting the manufacturers with a product display design, product development and marketing data via marketing methods commonly known. The manufactures may be offered opportunities to participate in other trade shows and conventions throughout North America.

Another option includes a group of manufacturers numbering at least fifty (50). Their product showcased may be recent as well as one that has been in production for a significant time. These products may be made throughout the world and by way of example and not limitation, may be made in Asia, including China.

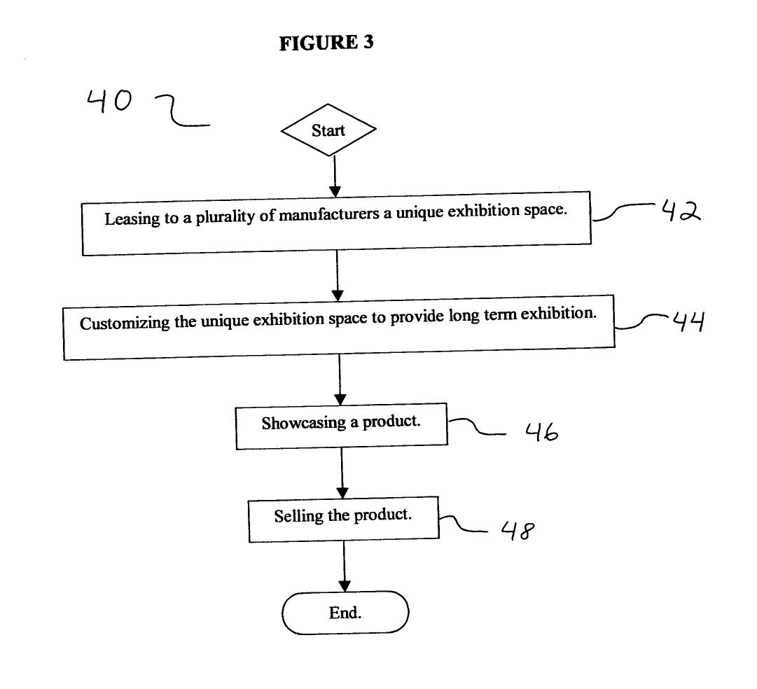

FIG. 3 illustrates a flowchart useful in describing another exemplary method for preparing a manufacturer's depot exhibition space and is generally represented by the numeral 40. Method 40 begins by leasing to a plurality of manufacturers a unique exhibition space corresponding respectively to each of the plurality of manufacturers, as indicated at 42. This step provides a long term exhibition space for the manufacturers with a lease term ranging from a month to a year to years. The product corresponding to each of the manufacturers may be made throughout the world. One option of the present invention is for showcasing and selling a product specifically made in Asia, including China.

Next is customizing the unique exhibition space, as indicated at 44. The manufacturers are able to showcase and sell their individual product on a long term, “permanent” basis, as defined above. The term of the lease may range from a monthly lease to a year lease to a multiple year lease. Next is showcasing the product, as indicated at 46 and then selling the product, as indicated at 48. Optionally, method 40 may include surveying the plurality of manufacturers to provide a detailed account of a manufacturer's business. The detailed account of the manufacturer's business may include information corresponding to their most recent product or a product that has been in production for significant time. That information could be used in conjunction with the manufacture or design of the unique exhibition space pertaining to a specific manufacturer. Another aspect is that the information may be used in assisting the manufacturers with a product display design, product development and marketing data via marketing methods commonly known. Optionally, the manufactures may be offered opportunities to participate in other trade shows and conventions throughout North America.

Another aspect of the present invention includes offering the manufacturers accommodations including meals and travel within the United States while doing business with the manufacturer's depot exhibition. This solves the problem many foreign manufacturers now have when their agents travel to the United States for business. Another benefit which may be provided to the manufacturers is a storage space where the manufacturers can store unsold product. This enables the manufacturers to store product not being displayed and showcased in their unique exhibition space. It can save the manufacturers a significant amount in overhead costs associated with shipping unsold product back and forth.

Still another aspect includes advertising the said manufacturer's depot exhibition space and/or products in local media including, by way of example and not limitation: newspaper, television, film, print, and radio. The manufacturers may number as great as fifty (50) or more and may each be billed fee ranging from a monthly membership to an annual membership fee for a year or multiple years.

The manufacturer's depot exhibition space may be located in a range of locations, including by way of example and not limitation: major metropolitan cities, towns, municipalities, neighborhoods and zoned areas. By way of example and not limitation, the major metropolitan cities may be: Los Angeles, San Francisco, Miami, New York, Chicago, Detroit, Cleveland, San Diego, New Orleans, Washington D.C., or Las Vegas.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention described by the foregoing includes all changes that come within the meaning, range and equivalence thereof and is intended to be embraced therein.

1. A method for preparing a manufacturer's depot exhibition space, comprising the steps of:
acquiring a real property right to a structure to provide said manufacturer's depot exhibition space in a specific location, wherein said real property right includes a leasing right or an ownership right;
contracting an agreement with a plurality of manufacturers, said agreement including a lease of an exhibition space within said manufacturer's depot exhibition space to provide a unique exhibition space, wherein said lease includes a term greater than a bi-monthly term;
customizing said exhibition space to provide said plurality of manufacturers with a permanent location to showcase and sell a product, wherein said product is relative to each of said plurality of manufacturers;
offering said plurality of manufacturers opportunities to meet direct customers and markets;
billing said plurality of manufacturers a membership fee;
establishing a storage space to provide said plurality of manufacturers with a product storage; and
advertising said manufacturer's depot exhibition space.

2. The method as set forth in claim 1 further comprises the step of surveying said plurality of manufacturers for an information packet relating to said product.

3. The method as set forth in claim 1 further comprises the step of selling said product on a wholesale basis from said plurality of manufacturers to a buyer.

4. The method as set forth in claim 1 further comprises the step of offering to said plurality of manufacturers accommodations, food and travel arrangements within the United States.

5. The method as set forth in claim 1 further comprises the step of assisting said plurality of manufacturers with a product display design.

6. The method as set forth in claim 5, wherein the step of assisting said plurality of manufacturers includes developing a product via a market feedback and a product demand.

7. The method as set forth in claim 1 further comprises the step of assisting said plurality of manufacturers in participating in other trade shows and conventions throughout North America.

8. The method as set forth in claim 1, wherein said plurality of manufacturers include at least a group of 50 manufacturers.

9. The method as set forth in claim 1, wherein said product is said plurality of manufacturers' most recent product.

10. The method as set forth in claim 1, wherein said specific location includes a location taken from the group consisting of: major metropolitan cities, towns, municipalities, neighborhoods and zoned areas.

11. The method as set forth in claim 1, wherein the term of said lease is at least a month.

12. The method as set forth in claim 11, wherein said term is a year.

13. The method as set forth in claim 1, wherein said product is made in Asia.

14. The method as set forth in claim 13, wherein said product is made in China.

15. The method as set forth in claim 1, wherein said membership fee is at least a monthly membership fee.

16. The method as set forth in claim 15, wherein said membership fee is an annual membership fee.

17. The method as set forth in claim 1, wherein advertising said manufacturer's depot exhibition space includes the step of advertising in a local media including newspaper, television, film, print, and radio.

18. A method for preparing a manufacturer's depot exhibition space, comprising the steps of:
surveying a plurality of manufacturers to provide a detailed account of a manufacturer's business, wherein said manufacturer's business includes information corresponding to a product;
contracting an agreement with said plurality of manufacturers, said agreement including a lease of a unique exhibition space corresponding respectively to each of said plurality of manufacturers;
customizing said unique exhibition space to provide said plurality of manufacturers with a permanent location to showcase and sell said product; and
showcasing said product corresponding respectively to each of said plurality of manufacturers on a permanent basis.

19. The method as set forth in claim 18 further comprises the step of offering said plurality of manufacturers accommodations including meals and travel.

20. The method as set forth in claim 18 further comprises the step of establishing a storage space to provide said plurality of manufacturers with a product storage.

21. The method as set forth in claim 18 further comprises the step of advertising said manufacturer's depot exhibition space.

22. The method as set forth in claim 21, wherein advertising said manufacturer's depot exhibition space includes the step of advertising in a local media including newspaper, television, film, print, and radio.

23. The method as set forth in claim 18 further comprises the step of billing said plurality of manufacturers a membership fee.

24. The method as set forth in claim 18 further comprises the step of assisting said plurality of manufacturers with a product display design.

25. The method as set forth in claim 24, wherein the step of assisting said plurality of manufacturers includes developing a product via a market feedback and a product demand.

26. The method as set forth in claim 18 further comprises the step of assisting said plurality of manufacturers in participating in other trade shows and conventions throughout North America.

27. The method as set forth in claim 18, wherein said plurality of manufacturers include at least a group of 50 manufacturers.

28. The method as set forth in claim 18, wherein said product is said plurality of manufacturers most recent product.

29. The method as set forth in claim 18, wherein said manufacturer's depot exhibition space is located in a location taken from the group consisting of: major metropolitan cities, towns, municipalities, neighborhoods and zoned areas.

30. The method as set forth in claim 18, wherein said lease includes a term of at least a month.

31. The method as set forth in claim 30, wherein said term is a year.

32. The method as set forth in claim 18, wherein said product is made in Asia.

33. The method as set forth in claim 32, wherein said product is made in China.

34. A method for preparing a manufacturer's depot exhibition space, comprising the steps of:
leasing to a plurality of manufacturers a unique exhibition space corresponding respectively to each of said plurality of manufacturers to provide a long term exhibition space, wherein said leasing includes a lease term greater than 29 days;
customizing said unique exhibition space to provide said plurality of manufacturers with said long term exhibition space to showcase and sell a product, wherein said product corresponds respectively to each of said plurality of manufacturers;
showcasing said product; and
selling said product.

35. The method as set forth in claim 34 further comprises the step of surveying said plurality of manufacturers to provide a detailed account of a manufacturer's business, wherein said manufacturer's business includes information corresponding to said product.

36. The method as set forth in claim 34 further comprises the step of offering said plurality of manufacturers accommodations including meals and travel.

37. The method as set forth in claim 34 further comprises the step of establishing a storage space to provide said plurality of manufacturers with a product storage.

38. The method as set forth in claim 34 further comprises the step of advertising said manufacturer's depot exhibition space.

39. The method as set forth in claim 38, wherein advertising said manufacturer's depot exhibition space includes the step of advertising in a local media including newspaper, television, film, print, and radio.

40. The method as set forth in claim 34 further comprises the step of billing said plurality of manufacturers a membership fee.

41. The method as set forth in claim 34 further comprises the step of assisting said plurality of manufacturers with a product display design.

42. The method as set forth in claim 41, wherein the step of assisting said plurality of manufacturers includes developing a product via a market feedback and a product demand.

43. The method as set forth in claim 34 further comprises the step of assisting said plurality of manufacturers in participating in other trade shows and conventions throughout North America.

44. The method as set forth in claim 34, wherein said plurality of manufacturers include at least a group of 50 manufacturers.

45. The method as set forth in claim 34, wherein said product is said plurality of manufacturers' most recent product.

46. The method as set forth in claim 34, wherein said specific location includes locations taking from the group consisting of major metropolitan cities, towns, municipalities, neighborhoods and zoned areas.

47. The method as set forth in claim 34, wherein said lease term is at least a month.

48. The method as set forth in claim 47, wherein said lease term is a year.

49. The method as set forth in claim 34, wherein said product is made in Asia.

50. The method as set forth in claim 49, wherein said product is made in China.
